(19) United States
(12) Patent Application Publication
(10) Pub. No.: US 2010/0217475 A1
(43) Pub. Date: Aug. 26, 2010

(54) LOW CURRENT VEHICLE ACCESSORY SYSTEM FOR TRUCKS AND ATVS

(75) Inventors: Peter C. Menze, Marquette, MI (US); John Manchester, Marquette, MI (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(73) Assignee: Ludington Technologies, Inc., Escanaba, MI (US)

(21) Appl. No.: 12/710,251

(22) Filed: Feb. 22, 2010

Related U.S. Application Data
(60) Provisional application No. 61/154,157, filed on Feb. 20, 2009.

(51) Int. Cl. G06F 19/00; H02J 7/00; G06F 7/00

(52) U.S. Cl. 701/29; 320/166; 701/36

(57) ABSTRACT

A capacitor module is utilized as part of a vehicle accessory system to accommodate the use of accessories that require high current power supplies on many different vehicles, thereby reducing the demands on the vehicle electrical systems. The capacitor module includes a plurality of ultracapacitors capable of maintaining relatively high charge levels and thereby accommodating the demands for short bursts of high current electrical power. Control circuitry is included to manage capacitor charging using lower current signals, thereby allowing for use of accessories on vehicles having lower capacity electrical systems. In one embodiment the accessories contemplated include a snow plow attached to a vehicle, with the snowplow having a hydraulic pump motor which requires high levels of electrical current for operation. Control circuitry manages charging using a relatively constant current electrical signal and discharging of the capacitors as necessary to operate the pump motor.

### RELATED APPLICATIONS

This application claims the benefit of previously filed U.S. Provisional application 61/154,157, filed Feb. 20, 2009 and entitled “A Low Current Snow Plow System or Other Vehicle Accessory System Operating on Trucks and ATVs”.

### FIELD OF INVENTION

The present invention relates to power supply systems which are capable of providing short bursts of high current electrical power. Certain variations of the power supply system are designed and configured to supply power to accessories carried on a vehicle, and to avoid the need for relatively high current electrical power demands which may strain the vehicle electrical system.

### BACKGROUND

Various accessories, such as snow plows, have been mounted on pickup and medium duty trucks for many years. The methods of operating these plows have progressed over the years, from manually raising and lowering the plow to the electric/hydraulic control methods which are almost universal used today. As these systems have become more sophisticated they have increased the demand on the vehicles electrical system. More specifically, these systems typically require short bursts of large electrical currents in order to properly operate. To accommodate this need, the vehicle electrical systems must have a large alternator and large capacity battery to operate the typical plow system. Such systems are often costly and may not be available on some vehicles.

As vehicle fuel economy and engine efficiency become a primary factor in new vehicle design, many additional concerns come into play. Modern manufacturers are no longer equipping their vehicles with the necessary high output electrical systems. Thus, alternatives are necessary to operate these accessories which demand high levels of electrical current.

### SUMMARY OF THE INVENTION

One method of meeting the electrical needs of snow plows (or other accessories that use short bursts of high electrical current) is to incorporate a system that utilizes a relatively small continuous current signal to charge a storage device, instead of short bursts of a very high current. One more specific method of accomplishing this is to use a bank of capacitors or ultra capacitors to store a desired charge, which can thus discharged in the form of short bursts of high current. Significantly, the capacitors can be charged using a lower level continuous current signal, thereby reducing the demands on a vehicle's electrical system.

Vehicles with low energy electrical systems, such as all-terrain vehicles, could also benefit from this type of application. With snow plows and bucket loaders of various types being installed on ATVs, a system using ultra capacitors is a more appropriate fit for the small output electrical systems typically included in these vehicles.

### BRIEF SUMMARY OF THE DRAWINGS

Further advantages of the present invention can be seen from the following detailed description of the preferred embodiments are, in conjunction with the attached drawings, in which:

FIG. 1 is a block diagram showing one embodiment of a system supplying power to snow plows;

FIG. 2 is a block diagram illustrating an alternative embodiment of a system supplying power to a snow plow;

FIG. 3 is a block diagram illustrating more details of a capacitor module; and

FIGS. 4-7 show a top side, perspective and front view, respectively, of a capacitor module contemplated to carry out the concepts of the invention.

### DETAILED DESCRIPTION OF PREFERRED EMBODIMENTS

In order to achieve the necessary power requirements for vehicle accessories, the various embodiments of the present invention utilize a capacitor module which is capable of storing energy for use at later times. The capacitors contained within the capacitor module can be charged using a more manageable current stream, thus avoiding unreasonable demands on the vehicle electrical system. As necessary for the operation of the desired accessory, control circuitry is then utilized to provide high current power signals using energy stored in these charged capacitors. In the description below, one example of an applicable accessory is a snow plow having hydraulic control systems to accommodate moving/positioning of the plow. Naturally, other alternative systems could be contemplated such as sprayers, material spreaders, painting systems, etc.

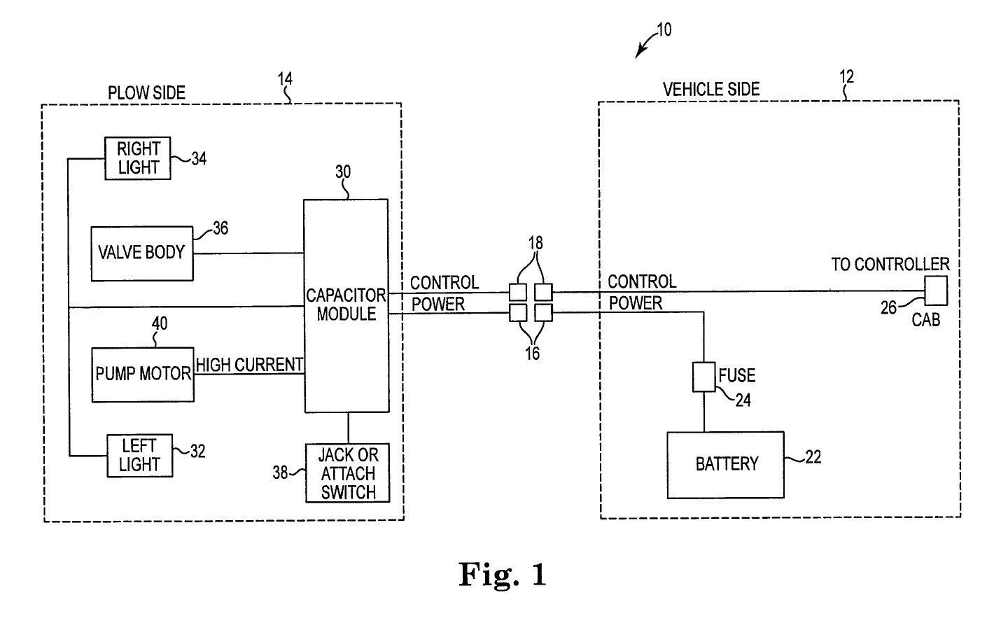

Referring now to FIG. 1, a potential embodiment of the present invention is further illustrated. In this particular example, an accessory power/control system 10 is utilized to control and power a snowplow which is attached to the front of a vehicle (vehicle and plow not specifically illustrated). More specifically, FIG. 1 is a block diagram illustrating the various electrical power/control components making up system 10. In this particular example, certain components are housed on a vehicle side 12 while other components are housed on a plow side 14. As can easily be anticipated by those familiar with plows, this type of separation is well known based upon the need to detach the plow mechanism. To provide coupling, a power connection 16 and a control connection 18 is utilized.

Referring now specifically to the vehicle side 12 of accessory power/control system 10, a connection to a battery 22 (via a fuse 24) provides power to power connection 16, and ultimately to the desired components on plow side 14. Similarly, a controller connection 26 (to accommodate connection to a control mechanism which is typically housed within the vehicle cab for easy access by the operator) is also included.

As illustrated in FIG. 1, plow side 14 includes a capacitor module 30 which is attached to control connections 18 and power connections 16. As will be further discussed below, capacitor module 30 includes the necessary circuitry to provide power management and plow control operations based upon multiple inputs. Capacitor module 30 has a number of connections on plow side 14 to provide electrical power/signals to various components. More specifically, capacitor module 30 is connected to both a left light 32 and a right light 34. As is well known, these are auxiliary headlights provided on the snow plow system. Capacitor module 30 also has an output to a valve body 36 to provide appropriate hydraulic controls to the various hydraulic components (not shown) which are typically included on a snow plow. Capacitor module 30 is also connected to a jack or attachment switch 38. This jack or attachment switch is utilized to confirm attachment of the snow plow and appropriately switch over operating conditions to receive vehicle power. Lastly, capacitor module has a high current output provided to a pump motor 40. As understood by those familiar with hydraulic technology, pump motor 40 operates for short periods of time while movements are being achieved. Additionally, pump motor 40 requires a fairly significant electrical power signal for operation, typically involving relatively large amounts of current. Motor 40 may include a switch reluctance motor, a three phase motor or any other well understood motor.

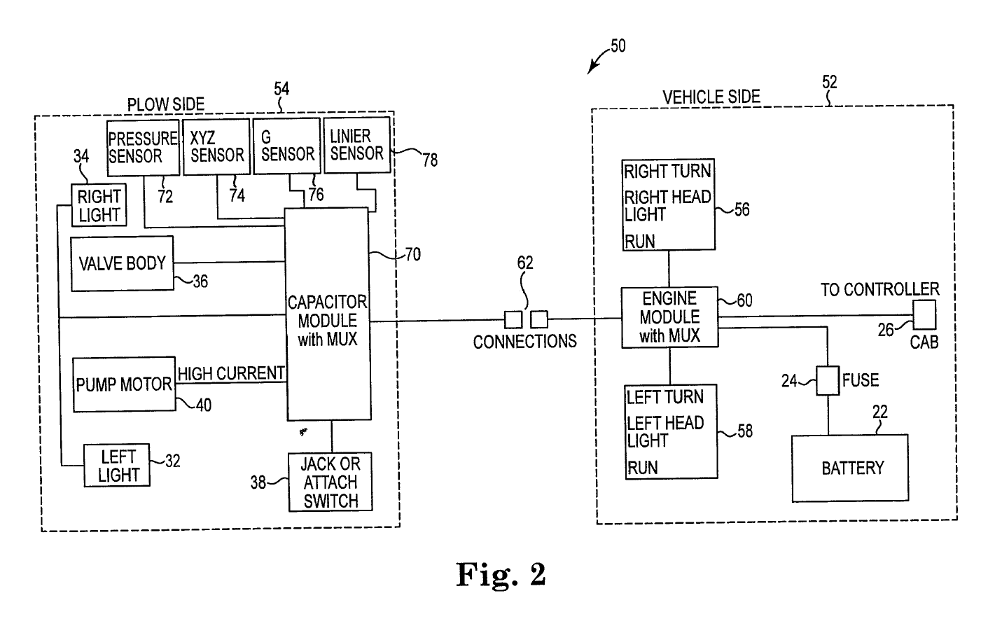

Referring now to FIG. 2, an alternative snow plow system 50 is illustrated in block diagram format. Alternative snow plow system 50 utilizes a plow with additional capabilities and features, and consequently, the control/power connections are appropriately modified. Again, the accessory involved here is a snow plow attached to a vehicle. In this particular variation, both the vehicle side 52 and the plow side 54 make use of multiplexers to provide power and control signals as necessary. Referring to vehicle side 52, an engine control module 60 is incorporated into this design. Engine control module 60 has connections to the same controller connection 26 and battery 22. Engine module 60 also has connections to existing vehicle lighting systems including the vehicle right side lights 56 and vehicle left side lights 58.

Based upon control signals provided by controller 26, engine module 60 will provide appropriate signals to either the existing vehicle lights (right side lights 56 and left side lights 58), or to various components provided on the plow side 54, depending upon the particular mode of operation. For example, when the plow is detached, engine module 60 will simply provide power to existing lights, based upon control signals provided by the operator.

Referring to plow side 54, several additional sensors have been added, with each sensor being attached to capacitor module 70. More specifically, these sensors include a pressure sensor 72, and XYZ sensor 74, a G sensor 76, and a linear sensor 78. Each of these sensors are capable of providing specific information to the capacitor module 70 thus allowing further enhanced operations. For example, a pressure sensor 72 will provide a signal indicative of the hydraulic pressure within the plow system. Having this information, the system will then be able to assess the operating characteristics of the various hydraulic components. Naturally, operation can be modified or halted if problems are detected. Similarly, XYZ sensor 74 will provide signals indicative of the plow orientation. XYZ sensor 74 could take many different forms, such as a magnetic sensor to detect positions, an optical sensor, etc. G sensor 76 (or accelerometer or physical force sensor) could be used to monitor plow down pressure being applied. Thus, in addition to monitoring and managing power, capacitor module is also capable of making adjustments to maintain relatively constant down pressure. Lastly, linear sensor 78 is utilized to measure linear movement forces encountered by the plow, which also indicate acceleration being achieved. Linear sensor 74 could also be an accelerometer, or any other type of sensor which is capable of detecting linear motion and/or acceleration. In addition to these sensors, other devices/components could be included to provide feedback regarding the operation of the plow. For example, it may be desirable to add cameras or optical sensors to detect the specific operation conditions. In many situations, the additional information provided may be helpful in determining whether adjustments are necessary.

Also connected to capacitor module 70 are the same outputs/component discussed above in relation to FIG. 1. Generally speaking, these are all the outputs necessary to provide plow operation and unnecessary control movements.

Generally speaking, it should be noted that the second accessory power/control system 50 shown in FIG. 2, has only a single connection 62 between engine module 60 and capacitor module 70. In this particular instance, both engine module 60 and capacitor module 70 will include appropriate multiplexers and communication logic to allow signals of multiple types to be transmitted via this single connection 62.

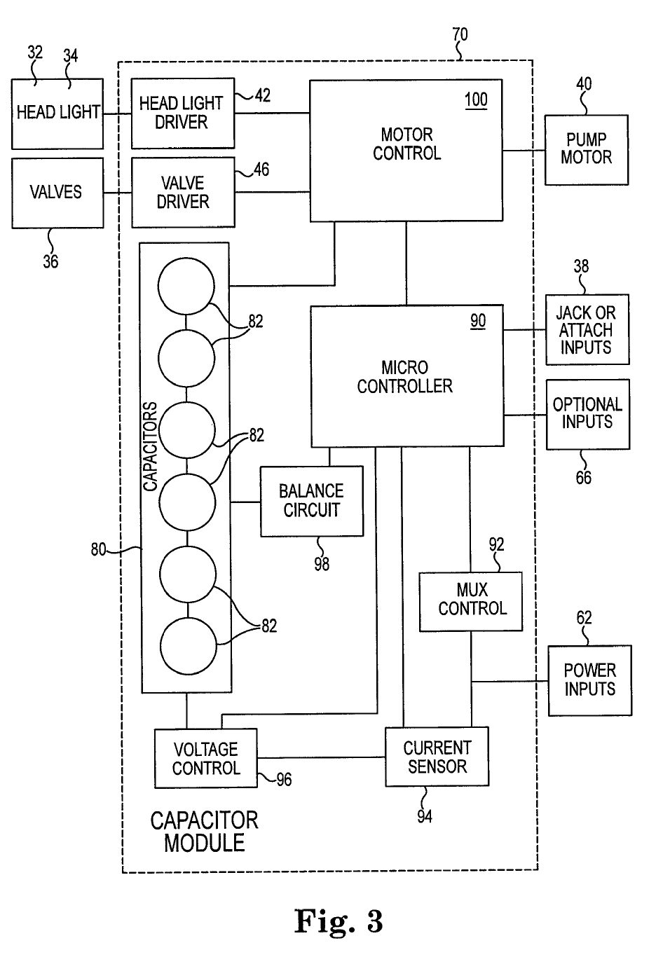

FIG. 3 illustrates a more detailed block diagram of capacitor module 70. A primary component contained within capacitor module 70 is a capacitor bank 80 made up of multiple capacitors 82. In this particular embodiment, it is contemplated that the capacitors used will be ultra capacitors or super capacitors, as they are known, which generally have very high energy densities when compared to “common” capacitors. References to capacitors however, can mean any form of capacitor or ultra capacitor or any other capacitor designation, so long as they meet the operational goals outlined herein. Also contained within capacitor module 70 is a microcontroller 90 and a motor control 100, both including various control circuitry and logic necessary to carry out certain defined functions.

As discussed above, capacitor module 70 has connections to the pump motor 40, valve body 36, light 32, light 34, and a power/control connection 62. Additionally, connection jack or attachment switch 38, and any number of additional optional input 66 could also be provided. For example, optional input 66 could include any one or number of the sensors discussed in connection with FIG. 2 above.

Contained within capacitor module 70, a number of specific control and operating circuits are utilized to coordinate overall operation. Again, capacitor module 70 includes microcontroller 90 which will contain the primary control logic for overall operation. Various inputs are provided from connection 62, via a multiplexer controller 92 to provide appropriate control and communication signals to microcontroller 90. One primary function of capacitor module 70 is to contain the necessary stored energy for operation of pump motor 40 at a desired time. Consequently, the charging of capacitors 82 is one function coordinated by capacitor module 70.

As indicated in reference to FIG. 2 above, connector 62 carries both power and control signals from vehicle side 52 to plow side 54. This includes providing the necessary power for charging of capacitors 82. Power is more specifically provided to capacitors via a current sensor 94 and a voltage controller 96. As illustrated, both current sensor 94 and voltage controller 96 are also connected to microcontroller 90, to help coordinate overall operation. Current sensor 94 will simply provide microcontroller 90 with information regarding current being supplied. Although FIG. 3 indicates the use of an in-line current sensor, it is also contemplated that additional current sensor could be incorporated. For example, a hall effect current sensor could be added adjacent to the input connection, the motor connection or at the capacitor charging connection. In these instances, the specific current being provided to each of these components would provide valuable information to microcontroller 90. Voltage controller 96 controls charging operations of capacitor bank 80 based upon provided control signals. In one exemplary situation, voltage controller 96 includes a boost circuit capable of boosting the voltage level of an output signal. In this case, 14 volt signal is received from the vehicle, and a 16 volt signal is provided to capacitor bank 80. Naturally, other alternatives may exist. Also contained within capacitor module 70 is a balancing circuit 98 which more specifically coordinates the functioning of capacitor bank 80. For example, balancing circuit 98 may be utilized to ensure the various capacitors within capacitor bank 80 are evenly charged.

As also illustrated, microcontroller 90 is connected to motor control 100. Although the primary function of motor control 100 is to coordinate operation of pump motor 40, this control will also coordinate power signals which ultimately are provided to valve 36 and lights 32 and 34. Specific drivers are utilized to coordinate operation of these components. More specifically, a valve driver 46 will coordinate operation of valve 36, and a headlight driver 32 will coordinate operation of headlights 32 and 34. Utilizing this connection, motor controller 100 is thus capable of managing the overall power distribution provided via capacitor bank 80 to the various systems involved. The circuitry involved in carrying out these particular features will likely include appropriate power transistors, or related analog circuit components. More specifically, these may include diode circuits, MOSFETS or several types of transistors.

In addition to the functions provided above, the inherent inductance provided when a motor is part of the accessory can also be beneficial. This inductance can be used to produce a back EMF, which in turn could be used for further capacitor charging. Further, the back EMF generated could be used to monitor motor operation (such as speed and positioning). Along these lines, the back EMF could also be used to determine the overall number of rotations provided by the motor, thus indicating related plow cylinder position. Lastly, this capability also provides the ability to incorporate motor boost, thus further increasing efficiency.

While the components of one embodiment are illustrated in FIG. 3 above, it is understood that certain variations are easily achieved and contemplated without departing from the overall spirit of the present invention. For example, FIG. 3 illustrates a voltage controller 96 utilized to coordinate charging of capacitor bank 80. Voltage controller 96 may include a voltage regulator, a current regulator, or both, as desired in a particular system. Alternatively, this component could be portrayed as a current controller as opposed to a voltage controller. Additionally, the discussion above contemplates multiplexed communication between the vehicle side and the plow side. Variations may include the use of wireless communication of control signals, a separate two-wire communication bus, optical communication or any possible communication scheme.

As generally discussed above, microcontroller 90 may be connected to several different inputs and sensors (e.g. pressure sensor 72, XYZ sensor 74, g-sensor 76, linear sensor 78, etc.). Microcontroller 90 can use all information received from these various sources to most efficiently manage energy use. This will include efficiently managing the way capacitor bank 80 is charged and the way energy is used by the plow system. For example, sensors can be used to monitor plow positions and avoid overrun when the plow reaches stops. As is well understood, these overrun conditions can strain the electrical system, using high levels of power for unnecessary operations. Microcontroller 90 could also monitor movements to determine if more efficient operating steps could be used. As an example, microcontroller 90 could monitor movement of the vehicle and utilize a slower raising rate for the plow when the vehicle is operating in reverse. Additionally, microcontroller 90 could monitor the operating characteristics and create an operating history to determine if changes in a user's habits could more efficiently manage power usage.

Although not specifically shown in FIG. 3, it is possible for the capacitor module to include an internal battery, such as a lithium battery. In this particular embodiment, microcontroller 90 would include appropriate controls to coordinate the charging of the battery, and its use as an additional supplemental energy source.

Certain components have been shown above to be housed or carried in particular locations (i.e. vehicle side versus plow side). It is contemplated that the locations of these systems could be easily modified depending upon other considerations. For example, depending upon the availability of space, an overall control module could be housed within the vehicle engine compartment, which contains both the engine module and the capacitor module. In this variation, each of these components would be contained within a single housing. Additional variations will be readily apparent to those skilled in the art.

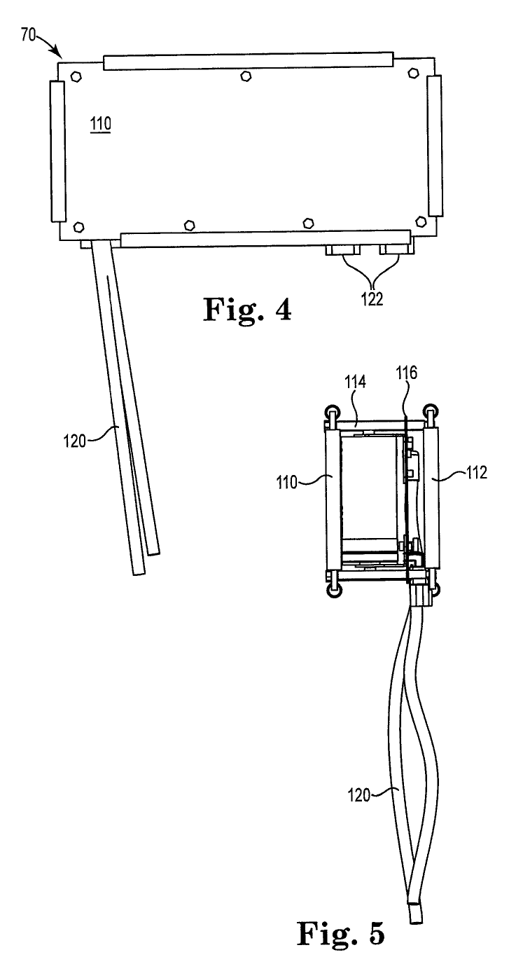

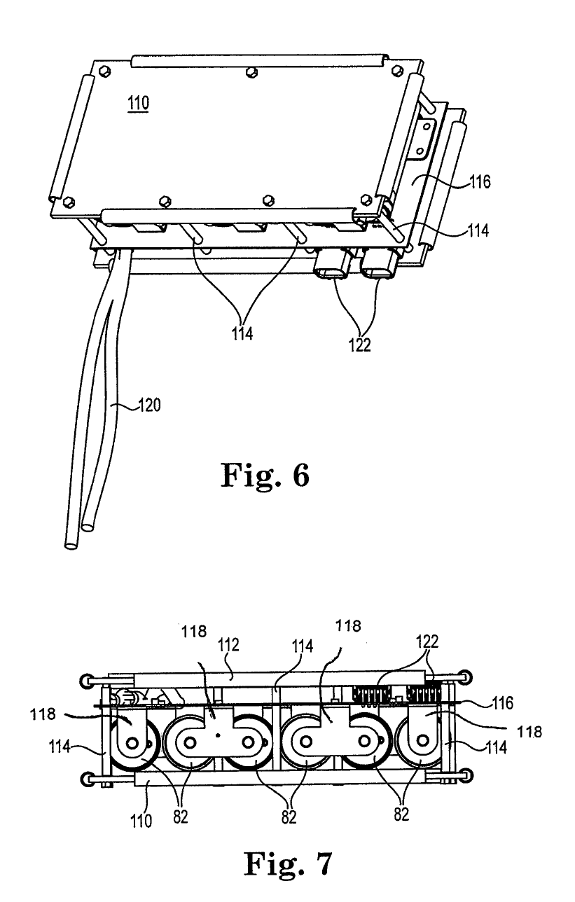

Referring now to FIG. 4-7, the physical layout of one embodiment of capacitor module 70 is illustrated. In these various figures, a front plate 110 and a back plate 112 are both illustrated. As shown, front plate 110 and back plate 112 are connected to each other via a plurality of standoffs or connecting posts 114. Also contained between front plate 110 and back plate 112 is a circuit board 116. As best illustrated in FIG. 7, capacitor module 70 includes a plurality of individual capacitors 82, as generally discussed above. Individual capacitors 82 are connected to circuit board 116 using a multifunction bracketing system 118 which provides both physical and electrical connections. Bracketing system 118 allows for the specific connection of capacitors 82 to the designated portions of circuitry contained on circuit board 116. In this manner, it is possible for the bracketing system 118 to operate as a buss bar, while also allowing for the appropriate connections to balancing circuit 98. By having bracketing system 118 connected directly to circuit board 116 also keeps the overall package size relatively small and compact. Also illustrated in FIG. 4-7 are a pair of high current output connections 120 and two connector ports 122. It is contemplated that high current output connections 120 would be attached to pump motor 40, while connector ports 122 are utilized for connection to engine module 60 and/or any other optional connections.

As mentioned above, capacitor module 70 includes circuit board 116. In this particular embodiment, circuit board 116 would include necessarily control circuitry generally discussed above, in conjunction with appropriate power connections to coordinate the desired capacitor operations. This will likely include appropriate traces on the circuit board to achieve current sensing, and heat management during the various capacitor charging and discharging operations. These traces (most likely copper traces on circuit board 116) can also provide a safety discharge for the capacitors. Additionally, certain other concerns may be addressed by the design of components contained on the circuit board. For example, appropriate isolation between control circuitry (i.e. micro controller 90) and the related power management circuitry may be necessary. This could be achieved by using appropriate opto-iosolators as necessary. Clearly, the actual design of circuit board 116 will likely vary depending on the overall concerns of the designers involved in creating the particular system.

Although various embodiments have been discussed and described above, it is contemplated that many variations in the actual design of products could certainly exist. The above described embodiments are meant to be illustrative in nature, and not intended to be limiting in any way. The applicant contends that the present invention includes all modifications and variations coming within the scope and spirit of the following claims.

We claim:

1. A power supply system for providing power to an accessory operating on a vehicle and using the existing vehicle electrical system, the power supply system comprising:
a capacitor bank having at least one capacitor capable of storing electrical energy and at least one output capable of providing power to the accessory;
a connector for electrically connecting the capacitor bank to the accessory; and
control circuitry coupled to the capacitor bank and the vehicle electrical system to achieve appropriate connections to cause the capacitor bank to be charged by the vehicle electrical system, the control circuitry regulating the capacitor charging process to cause charging to occur under predetermined conditions, the control circuitry further causing power to be supplied to the accessory as necessary.

2. The power supply system of claim 1 wherein the control circuitry includes a current regulator to control the level of current provided to the capacitor bank.

3. The power supply system of claim 1 wherein the control circuitry includes a voltage regulator to control the charging signal provided to the capacitor bank.

4. The power supply system of claim 1 wherein the control circuitry includes a current regulator and a voltage regulator to control the level of current provided to the capacitor bank.

5. The power supply system of claim 4 wherein the control circuitry is mounted on the vehicle.

6. The power supply system of claim 1 wherein the accessory is a snow plow.

7. The power supply system of claim 1 wherein the control circuitry can detect an operating condition and provide a status signal, wherein the status signal is at least one signal selected from the group of an audible warning sound, an audible voice signal, a visual warning light or visual display.

8. The power supply system of claim 1 further comprising an accessory controller coupled to the control circuitry to provide operational control of the accessory.

9. The power supply system of claim 8 wherein the accessory controller is coupled to the control circuitry via a connection selected from the group of a wireless connection, an optical connection, a bus connection, a two wire DC buss or a CAN buss.

10. The power supply system of claim 1 wherein the control circuitry comprises a microcontroller circuit for monitoring a plurality of operating parameters.

11. The power supply system of claim 10 wherein the operating parameters comprise voltage levels, current levels, operating temperatures and operating times.

12. The power supply system of claim 1 wherein the capacitor bank comprises a load which can be used as heating circuit to provide heat if a freezing condition is detected and/or can be used to create a safety discharge circuit.

13. The power supply system of claim 1 wherein the capacitors are contained within a sealed non customer serviceable module.

14. The power supply system of claim 1 wherein the capacitor bank comprises a plurality of capacitors and a circuit board, wherein the plurality of capacitors and the circuit board are physically and electrically connected by a bracketing system.

15. The power supply system of claim 3 wherein the voltage regulator comprises a boost circuit capable of providing an output at a voltage level above the voltage level of a received input.

16. The power supply system of claim 1 wherein the control circuitry includes a balancing circuit.

17. The power supply system of claim 1 wherein the control circuitry further includes a relay to cause power to be transferred from the capacitors to the accessory.

18. A capacitor module to be used in conjunction with a vehicle electrical system to power an accessory, the capacitor module comprising:
a capacitor bank comprising a plurality of capacitors, the capacitor bank capable of storing energy which is supplied in the form of a relatively low level constant current signal provided by the vehicle electrical system, wherein the relatively low level constant current signal is within the common operating characteristics of the vehicle electrical system;
a connector system for coupling the capacitor module to the vehicle electrical system and to an accessory control device; and
a microcontroller coupled to the capacitor bank for monitoring and controlling the amount of current provided by the vehicle electrical system, the microcontroller further coupled to the accessory control device for coordinating signals necessary to control the accessory, including coordinating the supply of power from the capacitor bank when needed to appropriately power the accessory.

19. The power supply system of claim 3 wherein the voltage regulator has a boost circuit to provide an output signal having a voltage level higher than a received input signal.

20. The power supply system of claim 1 wherein the control circuitry has optical isolation to protect components from high voltage signals.

21. The power supply system of claim 1 wherein the control circuitry further comprises an overcurrent protection device to protect the capacitor bank and the vehicle.

22. The power supply system of claim 1 wherein the accessory includes a motor, and a motor winding can be separated and controlled so that an inherent inductance is used to provide voltage boost.

23. The power supply system of claim 1 wherein the control circuitry comprises a hall effect sensor to monitor a predetermined operating current level.
